(19) United States
(12) Patent Application Publication
(10) Pub. No.: US 2012/0090912 A1
(43) Pub. Date: Apr. 19, 2012

(54) Mounting Systems for Transverse Front Wheel Drive Powertrains with Decoupled Pitch Damping

(75) Inventors: Daniel G. Gannon, Milford, MI (US); Sam M. Jomaa, Northville, MI (US); Ping Lee, Kitchener (CA); Dennis J. Kinchen, Brighton, MI (US)

(73) Assignee: GM GLOBAL TECHNOLOGY OPERATIONS, INC., DETROIT, MI (US)

(21) Appl. No.: 12/904,350

(22) Filed: Oct. 14, 2010

(51) Int. Cl. B60K 5/12; B60K 17/00; B62D 21/00

(52) U.S. Cl. 180/312

(57) ABSTRACT

A powertrain mounting system with a decoupled hydraulic bushing device as a torque reacting element. An elastic element of the bushing mount vibrates in response to powertrain pitch torque. At high vibration amplitude of the elastic element, high hydraulic damping is provided via a main liquid reservoir, bounce inertia track and bellowed secondary liquid reservoir, with a decoupler fluid passage being passively disabled. At low vibration amplitude of the elastic element, minimal hydraulic damping is provided via a decoupler system.

### TECHNICAL FIELD

The present invention relates to mounting systems used for mounting a powertrain in motor vehicle applications, particularly to neutral torque roll axis mounting systems and pendular mounting systems, and more particularly to a fully decoupled pitch damping hydraulic bushing at the torque reacting mount components thereof

### BACKGROUND OF THE INVENTION

Powertrain mounting systems used in motor vehicle applications include the “four-point neutral torque roll axis” (hereafter simply “NTA”) mounting system, exemplified at FIG. 1, and the “pendular” mounting system, exemplified at FIG. 2. In the NTA mounting system 10 of FIG. 1, there is included (dispositions being relative to forward travel direction 15 of the motor vehicle) a right-hand load bearing mount 12, a left-hand load bearing mount 14, a front torque reacting bushing mount 16, and a rear torque reacting bushing mount 18. In the pendular mounting system 20 of FIG. 2, there is included (dispositions being again relative to forward travel direction 25 of the motor vehicle) a right-hand load bearing mount 22, a left-hand load bearing mount 24, and a (rear disposed) torque reacting strut mount 26. In either mounting system 10, 20, when the powertrain is mounted, the resulting force/torque loading created by the powertrain involves the two load bearing mounts being disposed in alignment with the torque roll axis 35, 45 of the powertrain, which passes through its center of gravity, and the one or two torque reacting mount components (i.e., the bushing mounts 16, 18, or the torque reacting strut mount 26) being disposed so as to carry minimal static force pre-loading, while providing reaction to powertrain pitch arising from torque loading about the torque roll axis, wherein the pitch of the powertrain is registered at the torque reacting mount component(s) generally as a couple or moment in a plane normal to the torque roll axis.

As shown by way of example at FIG. 3, the torque reacting mount component(s) 40 include a first torque reacting mount component member 42 which is connected by way of example to the cradle 44 (as per exemplar cradles 30 and 32 in FIGS. 1 and 2, respectively), and a second torque reacting mount component member 46 which is connected by way of example to the powertrain 48. An elastic torque reacting mount bushing 50 flexibly connects the first and second torque reacting mount component members 42, 46. FIGS. 4 through 6 depict schematically how the prior art torque reacting mount bushing 50 operates. At FIG. 4, it is seen that an elastic element 52, such as for example rubber, is connected distally to the first torque reacting mount component member 42, and generally centrally, via a bushing rod 54, which is in the form of a through bolt, to the second torque reacting mount component member 46. As shown at FIGS. 5 and 6, the powertrain pitching torque loads 56, 58 act essentially perpendicular to the bushing rod 54 and result in pitch at the torque reacting mount component member(s), wherein the elastic element thereof reacts in elastic deformation depending on the mutually opposite directions of the pitching torque loads.

When the motor vehicle is in operation, powertrain pitching due to various levels of torque loading occurs at the torque reacting mount component member(s), which includes both high and low vibration amplitudes for which damping and stiffness requisites vary. High vibration amplitude events include engine start/stop, garage shifts, rough road shake, and smooth road chuggle. Low amplitude vibration events include idle vibration and smooth road shake vibration. Therefore, a drawback of prior art torque reacting mount components utilizing solely an elastic element for reaction to powertrain pitch, is that the elastic element is unable to adjust itself in terms of stiffness and damping to the various high and low vibration amplitudes presented to it during powertrain pitching events.

A dual aspect mount device known in the prior art is a hydraulic mount used for left and right bearing load powertrain mounts. In a first aspect, a hydraulic mount provides location of one object, such as a motor vehicle powertrain, with respect to a second object, as for example the frame (or cradle) of the motor vehicle. In a second aspect, the hydraulic mount provides damping of vibration or low dynamic stiffness as between the first and second objects, as for example damping or isolating of engine vibration with respect to the frame of the motor vehicle. Hydraulic mounts which are used for motor vehicle applications are represented, for example, by U.S. Pat. Nos. 4,828,234, 5,215,293 and 7,025,341.

U.S. Pat. No. 5,215,293, by way of example, discloses a hydraulic mount having a rigid upper member which is bolted to the powertrain and a lower powertrain member which is bolted to the frame (or cradle), wherein the upper and lower members are resiliently interconnected. The upper member is connected to a resilient main rubber element. Vibration of the main rubber element in response to engine vibration is transmitted to an adjoining upper fluid chamber. The upper fluid chamber adjoins a rigid top plate having an idle inertia track there through which communicates with an idle fluid chamber. The idle fluid chamber is separated from an idle air chamber by an idle diaphragm. The idle air chamber is selectively connected to atmosphere or to engine vacuum in order to selectively evacuate the idle air chamber in which case the idle diaphragm is immobilized. A bounce inertia track is formed in the top plate and communicates with a lower fluid chamber which is fluid filled. A bellows separates the lower fluid chamber from a lower air chamber which is vented to the atmosphere.

The idle inertia track has a larger cross-sectional area and a shorter length than that of the bounce inertia track, such that the ratio provides resonant frequency damping at the respectively selected resonance frequencies. In this regard, the resonance frequency of the fluid flowing through the idle inertia track is set to be higher than that of the fluid flowing through the bounce inertia track. As such, this prior art hydraulic mount is able to effectively damp relatively low frequency vibrations over a lower frequency range, such as powertrain shake or bounce, based on resonance of a mass of the fluid in the bounce inertia track, while, on the other hand, the idle inertia track is tuned so that the hydraulic mount exhibits a sufficiently reduced dynamic stiffness with respect to relatively high-frequency vibrations over a higher frequency range, such as engine idling vibrations, based on the resonance of a mass of the fluid in the idle inertia track.

In operation, vibrations in the higher frequency range are isolated by operation of the induced fluid oscillations in the upper fluid chamber passing through the idle inertia track and the resilient deformation of the main resilient element and the idle diaphragm in that the idle air chamber is at atmospheric pressure. For vibrations in the lower frequency range, the idle air chamber is evacuated by being connected to engine vacuum, wherein now the fluid oscillations of the upper fluid chamber travel through the bounce inertia track and are damped thereby in combination with the resilient deformation of the main resilient element and the bellows.

Hydraulic mounts are employed as load bearing mounts or as a combination load bearing and torque reacting mounts. In torque roll axis mounting systems, like the NTA and pendular systems, the torque reacting elements in the system are predisposed to carry minimal static preload and to primarily react to powertrain torque. In particular, bushing style mounts as the torque reacting elements in NTA and pendular systems provide specific benefits to the powertrain mounting system overall isolation not offered by other types of hydraulic mounts. Accordingly, what is needed in the art is to implement passive bushing style mounts not controlled by external devices that provide low stiffness at small amplitudes of powertrain pitch vibration and high damping at large amplitudes of powertrain pitch vibration.

### SUMMARY OF THE INVENTION

The present invention packages a hydraulic device into a torque reacting mount bushing of a torque reacting mount component of a powertrain mounting system, for example an NTA or pendular mounting system, so as to provide high hydraulic damping and stiffness at high vibration amplitude, and minimal to no hydraulic damping and stiffness at low vibration amplitude, thereby enabling the mounting system to have passively decoupled powertrain pitch damping as between high and low amplitudes of vibration.

The hydraulic device torque reacting mount bushing according to the present invention is configured in a generally cylindrical shape which permits replacement packaging into the conventional cylindrically shaped bushing mount application of the torque reacting mount component. A rigid outer shell connects to a first torque reacting mount component member. An elastic member disposed within the outer shell is composed of a main elastic element and a main elastic body. The main elastic element has a generally centrally disposed bushing rod connected thereto, the bushing rod being connected to a second torque reacting mount component member. By way of example, the outer shell is in connection through the first torque reacting mount component member with the cradle and the bushing rod is in connection through the second torque reacting mount component member with to the powertrain.

The distal ends of the main elastic element are integrally connected to the main elastic body. A main liquid reservoir is located on a first side of the main elastic element, while the other, second, side of the main elastic element is exposed to the atmosphere. A bounce inertia track is hydraulically connected to the main liquid reservoir and extends to a secondary liquid reservoir which is separated from the atmosphere by a flexible bellows, the bellows being connected with the main elastic body. A fluid passage is hydraulically connected to the main liquid reservoir and hydraulically communicates with the secondary liquid reservoir. Disposed therein is a decoupler system which includes perforated sidewalls and a loose compliant membrane disposed therebetween.

In operation, vibrations of low amplitude are transmitted by the main elastic element to the main liquid reservoir and because the compliant membrane is free to move, the vibrations passing through the main liquid reservoir transmit through the decoupler system into the decoupler fluid passage, whereby low pitch stiffness and low to no hydraulic damping will be provided. For vibrations of high amplitude, the vibrations are transmitted by the main elastic element to the main liquid reservoir such that liquid is displaced (in or out) of the main liquid reservoir and exchanged with the secondary liquid reservoir via the bounce inertia track and resilient compliance of the bellows. At the same time, the amplitude of the vibration causes the compliant membrane of the decoupler system to be hydraulically pressed into occluding relation with a perforated sidewall of the decoupler system, thereby disabling operation of the compliant membrane. Thus, for high amplitude vibrations, high hydraulic damping and high pitch stiffness are provided. Accordingly, provided are high hydraulic damping and stiffness at high vibration amplitude, and minimal to no hydraulic damping and stiffness at low vibration amplitude, enabling the mounting system to have passively decoupled pitch damping at high and low amplitudes of vibration.

Accordingly, it is an object of the present invention to utilize a hydraulic device as the torque reacting mount bushing of a torque reacting mount component of a powertrain mounting system, for example an NTA or pendular mounting system, so as to provide high hydraulic damping and stiffness at high vibration amplitude, and minimal to no hydraulic damping and stiffness at low vibration amplitude, thus enabling the mounting system to have passively decoupled pitch damping as between high and low amplitudes of vibration.

This and additional objects, features and advantages of the present invention will become clearer from the following specification of a preferred embodiment.

### BRIEF DESCRIPTION OF THE DRAWINGS

FIG. 1 is a schematic, perspective view of a prior art NTA mounting system for a motor vehicle.

FIG. 2 is a schematic, perspective view of a prior art pendular mounting system for a motor vehicle.

FIG. 3 is a perspective view of a prior art torque reacting mount component of a prior art powertrain mounting system.

FIGS. 4 through 6 depict examples of operation of a prior art elastic element of a prior art torque reacting mount bushing of the torque reacting mount component of a prior art powertrain mounting system.

FIG. 7 is a sectional view, schematically depicting structural and functional principles of operation of a hydraulic device torque reacting mount bushing for a torque reacting mount component according to the present invention.

FIG. 8 is a side view of a hydraulic device torque reacting mount bushing for a torque reacting mount component according to the present invention.

FIG. 9 is an end plan view of the hydraulic device torque reacting mount bushing for a torque reacting mount component according to the present invention, seen along line 9-9 of FIG. 8.

FIG. 10 is a sectional view of the hydraulic device torque reacting mount bushing for a torque reacting mount component according to the present invention, seen along line 10-10 of FIG. 8.

FIG. 11 is a sectional view of the hydraulic device torque reacting mount bushing for a torque reacting mount component according to the present invention, seen along line 11-11 of FIG. 10.

FIG. 12 is a perspective view of a torque reacting mount component of a powertrain mounting system, shown including the hydraulic device torque reacting mount bushing according to the present invention.

FIGS. 13 and 14 depict examples of operation of the hydraulic device torque reacting mount bushing for a torque reacting mount component according to the present invention in response to high vibration amplitude.

### DESCRIPTION OF THE PREFERRED EMBODIMENT

Referring now to the Drawings, aspects of a hydraulic device torque reacting mount bushing for a torque reacting mount component of a powertrain mounting system according to the present invention are depicted in FIGS. 7 through 14.

FIG. 7 schematically depicts the structural and functional principles of operation of a hydraulic device torque reacting mount bushing 1000 according to the present invention.

A rigid outer shell 1004 connects to a first torque reacting mount component member 1002′. A main elastic element 1006 has a generally centrally disposed insert 1014 which is connected to a second torque reacting mount component member 1002″. A main liquid reservoir 1022 is disposed sealingly on a first side 1006′ of the main elastic element 1006, while the other, second, side 1006″ of the main elastic element is exposed to the atmosphere 1024. A bounce inertia track 1026 hydraulically connects to the main liquid reservoir 1022 and extends to a secondary liquid reservoir 1030 which is separated from the atmosphere 1024 by a flexible bellows 1032. A decoupler fluid passage 1034 hydraulically connects to the main liquid reservoir 1022 and hydraulically communicates with the secondary liquid reservoir 1030. Disposed in the decoupler fluid passage 1034 is a decoupler system 1040 in the form of a pair of parallel and mutually spaced apart perforated side walls 1042, 1044, between which is disposed a loose, compliant membrane 1046 which is sized to superpose the perforations 1048 of the perforated sidewalls. Liquid, preferably glycol 1025 fills the main and secondary liquid reservoirs 1022, 1030, the bounce inertia track 1026, the decoupler fluid passage 1034 and the decoupler system 1040.

In operation with respect to high amplitude vibrations, the vibrations are transmitted by the main elastic element 1006 to the main liquid reservoir 1022 such that liquid is displaced with respect to the main liquid reservoir and exchanged with the secondary liquid reservoir via the bounce inertia track 1026 and resilient compliance of the bellows 1032. At the same time, the high amplitude of the vibration causes the compliant membrane 1046 to be hydraulically pressed into occluding relation to the perforations 1048 of one or the other of the perforated sidewalls 1042, 1044, thereby disabling operation of the decoupler system 1040. Thus, for high amplitude vibrations, high pitch stiffness and high hydraulic damping are provided.

Further in operation with respect to low amplitude vibrations, the vibrations are transmitted by the main elastic element 1006 to the main liquid reservoir 1022, and because the compliant membrane 1046 is loosely free to move between the perforated sidewalls 1042, 1044 without occluding the perforations 1048, these low amplitude vibrations pass through the main liquid reservoir, then transfer through the decoupler system 1040 and into the decoupler fluid passage 1034, whereby minimal pitch stiffness and minimal to no hydraulic damping is provided as a reaction to the low amplitude powertrain pitching.

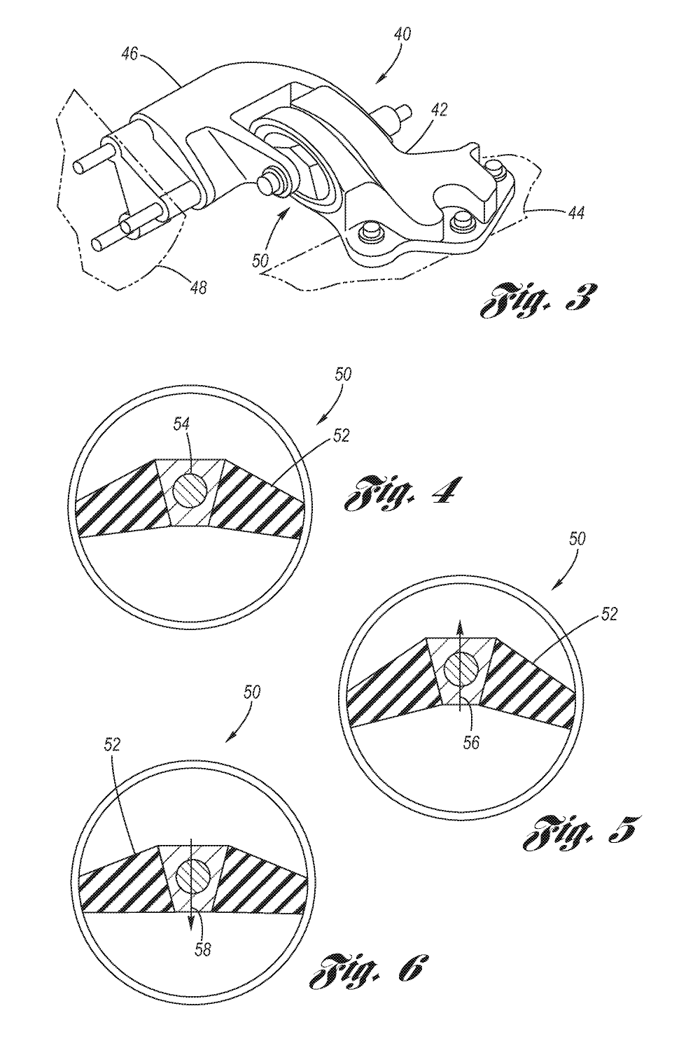

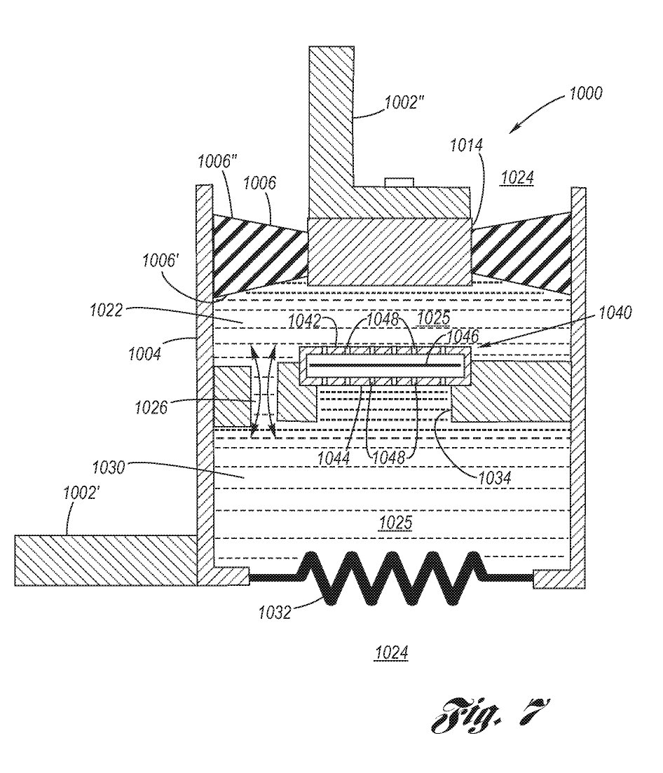

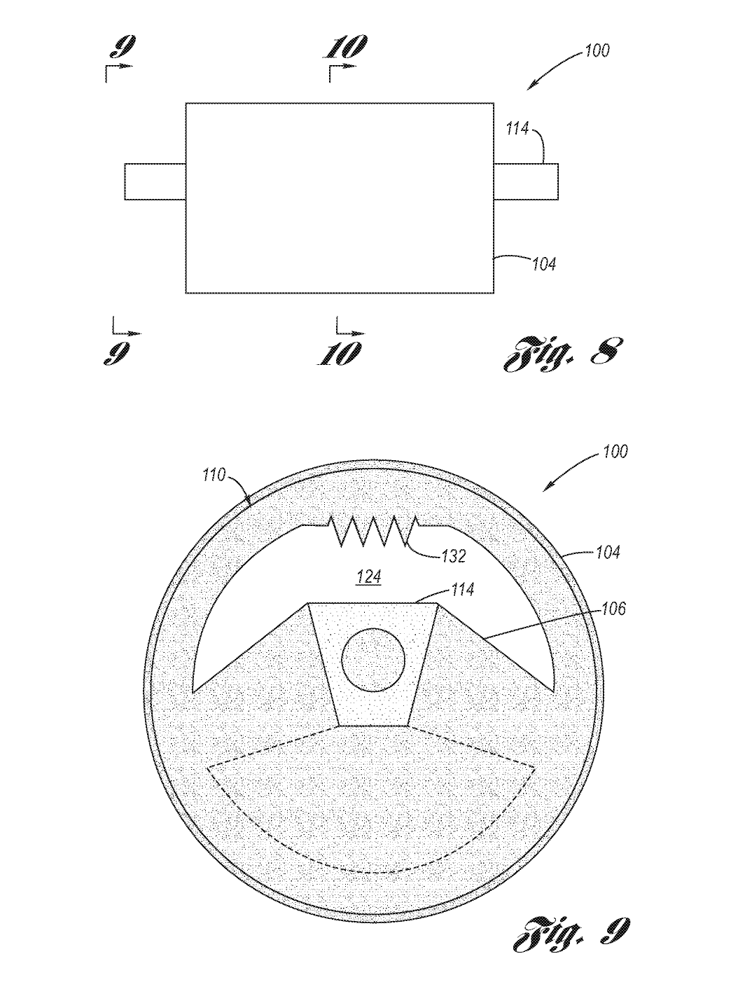

Turning attention now to FIGS. 8 through 14, a preferred embodiment of the hydraulic device torque reacting mount bushing 100 according to the present invention will be detailed, being configured in a generally cylindrical shape, the packaging of which allows for its replacement of the conventional cylindrically shaped prior art torque reacting mount bushing application (as per example FIG. 3).

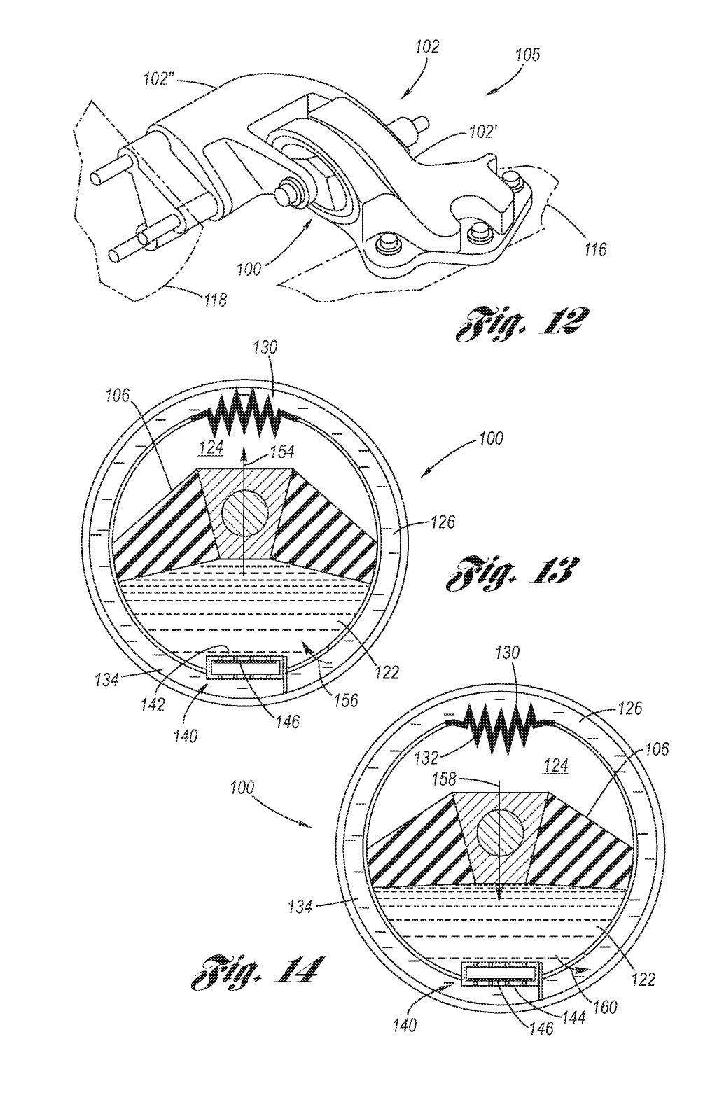

FIG. 12 depicts a detailed example of a powertrain mounting system 105, as for example an NTA or pendular mounting system, including at least one torque reacting mount component 102 which includes a first torque reacting mount component member 102′, by way of example connected to a cradle 116, a second torque reacting mount component member 102″, by way of example connected to a powertrain 118, and a hydraulic device torque reacting mount bushing 100 flexibly interconnecting the first and second torque reacting mount components such as to provide high hydraulic damping and stiffness at high vibration amplitude, and minimal to no hydraulic damping and stiffness at low vibration amplitude, thus enabling the mounting system 105 to have passively decoupled pitch damping as between high and low amplitudes of vibration around the torque roll axis of the powertrain.

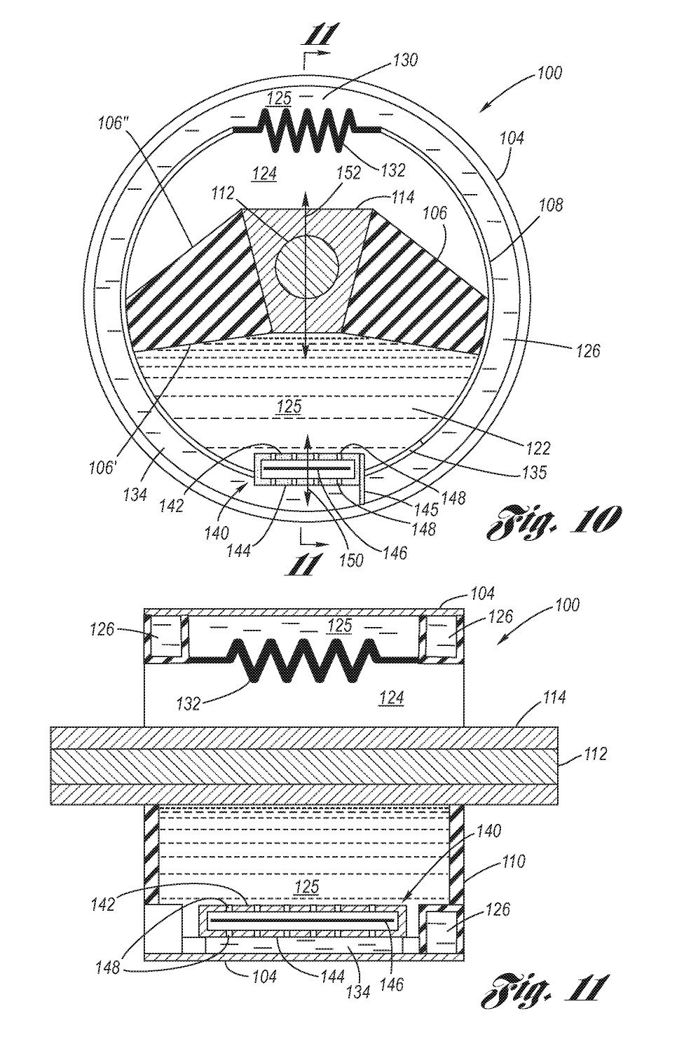

A rigid outer shell 104 connects to a first torque reacting mount component member, by way of example 102′ in FIG. 12. A molded elastic bushing 110 integrally includes a main elastic element 106, wherein the molded elastic bushing is molded over a metallic cage 108 which provides structural definition to the molded elastic bushing (see FIG. 10, where in order to show the cage, a portion of the molded elastic bushing is not shown). The main elastic element 106 has a generally centrally disposed insert 114 which is connected, for example by a bushing rod 112 in the preferred form of a through bolt, to the second torque reacting mount component member 102″ which is connected to the powertrain 118. Further by way of example, the outer shell 104 is connected, via the first torque reacting mount component member 102′, to the cradle 116, wherein the term “cradle” is a bolt-on structural member, i.e., a motor vehicle sub-frame, used for mounting of the powertrain.

A main liquid reservoir 122 is disposed sealingly on a first side 106′ of the main elastic element 106, while the other, second, side 106″ of the main elastic element is exposed to the atmosphere 124. A bounce inertia track 126 is formed partly of the molded elastic bushing 110 and partly of the outer shell 104. The bounce inertia track 126 hydraulically connects (see opening 135) to the main liquid reservoir 122 and extends to a secondary liquid reservoir 130 which is separated from the atmosphere 124 by a flexible bellows 132 which is connected with the molded elastic bushing 110. A decoupler fluid passage 134 is formed partly of the molded elastic bushing 110 and partly of the outer shell 104. The decoupler fluid passage 134 hydraulically connects to the main liquid reservoir 122 and hydraulically communicates with the secondary liquid reservoir 130. Disposed in the decoupler fluid passage 134 is a decoupler system 140 in the form of a pair of parallel and mutually spaced apart perforated side walls 142, 144, between which is disposed a loose, compliant membrane 146 which is sized to superpose the perforations 148 of the perforated sidewalls. Liquid, preferably glycol 125 fills the main and secondary liquid reservoirs 122, 130, the bounce inertia track 126, the decoupler fluid passage 134 and the decoupler system 140. The bounce inertia track 126 and decoupler fluid passage 134 are separated, as for example by a wall 145.

Operation of a powertrain mounting system 105 having the hydraulic device torque reacting mount bushing 100 for each torque reacting mount component 102 thereof will now be described.

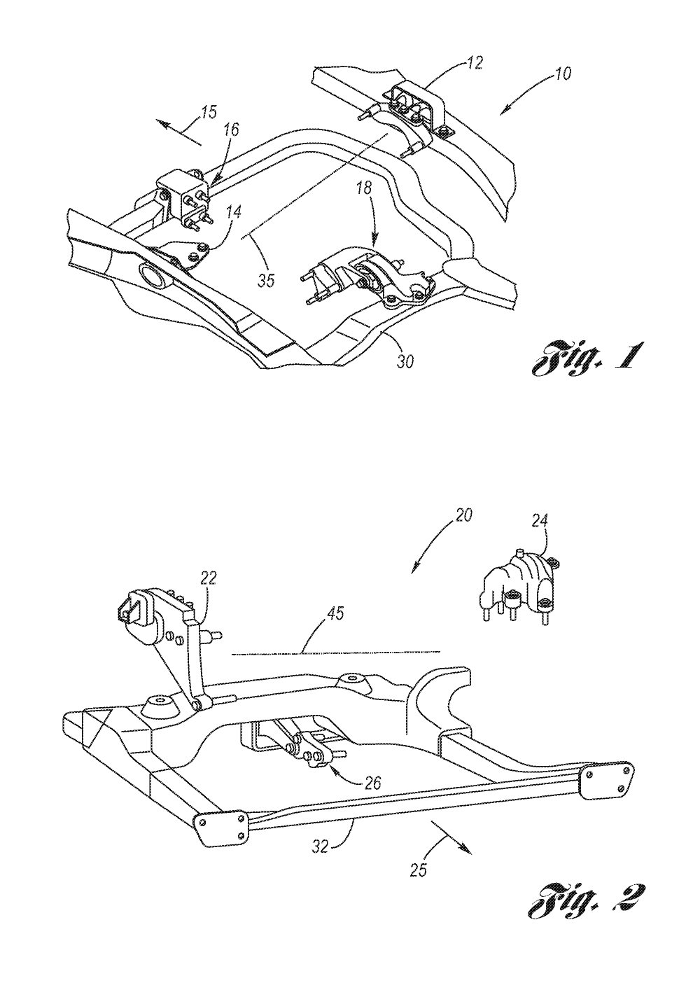

Powertrain torque and torque transients create powertrain pitch vibration about the torque roll axis (see FIGS. 1 and 2) which is reacted by the hydraulic device torque reacting mount bushing in the form of low and high amplitude vibration of the main elastic body 106 with respect to the outer shell 104 (see FIGS. 9 and 10).

As shown at FIG. 10, low amplitude vibrations 152 are transmitted by the main elastic element 106 to the main liquid reservoir 122, and because the compliant membrane 146 is loosely free to move 150 between the perforated sidewalls 142, 144 without occluding the perforations 148, these low amplitude vibrations pass through the main liquid reservoir, then transfer through the decoupler system 140 and into the decoupler fluid passage 134, whereby minimal pitch stiffness and minimal to no hydraulic damping is provided as a reaction to the low amplitude powertrain pitching.

As shown at FIGS. 13 and 14, vibrations of high amplitude 154, 158 are transmitted by the main elastic element 106 to the main liquid reservoir 122 such that liquid is displaced (inward 156 at FIG. 13 or outward 160 at FIG. 14) with respect to the main liquid reservoir and exchanged with the secondary liquid reservoir 130 via the bounce inertia track 126 and resilient compliance of the bellows 132. At the same time, the high amplitude of the vibration causes the compliant membrane 146 to be hydraulically pressed into occluding relation to the perforations 148 of one or the other of the perforated sidewalls 142, 144, depending on the direction 154 (FIG. 12), 158 (FIG. 13) of the vibration, thereby disabling operation of the decoupler system 140. Thus, for high amplitude vibrations, high pitch stiffness and high hydraulic damping are provided.

Accordingly, the present invention provides high hydraulic damping and stiffness at high vibration amplitudes of powertrain pitching around the torque roll axis of the powertrain, and minimal to no hydraulic damping and stiffness at low vibration amplitudes of powertrain pitching around the torque roll axis of the powertrain, enabling the mounting system to have passively decoupled pitch damping as between high and low amplitudes of vibration.

The demarcation between “high” and “low” vibration amplitudes of powertrain pitching around the torque roll axis of the powertrain whereat the decoupler system is active or disabled is determined by empirical testing or computer modeling for the particular vehicle application. However, by way merely of exemplification, any amplitude above about 0.5 millimeter of powertrain pitch acting at the hydraulic device torque reacting mount bushing may be considered a “high” vibration amplitude.

Further, by exemplification the terms “minimal” and “high” as used to describe damping and/or stiffness may, for example, represent about at least an order of magnitude difference, wherein the term “minimal” is the lesser therebetween.

To those skilled in the art to which this invention appertains, the above described preferred embodiment may be subject to change or modification. Such change or modification can be carried out without departing from the scope of the invention, which is intended to be limited only by the scope of the appended claims.

1. A motor vehicle powertrain mounting system comprising:
a powertrain having a torque roll axis;
a structural member upon which said powertrain is mountable;
a plurality of load bearing mounts supporting said powertrain with respect to said structural member, wherein said load bearing mounts are disposed in alignment with the torque roll axis of said powertrain;
at least one torque reacting mount component connected to said structural member and said powertrain and disposed so as to react to powertrain pitch torque around said torque roll axis, said torque reacting mount component comprising:
a first torque reacting mount component member connected to one of said structural member and said powertrain;
a second torque reacting mount component member connected to the other of said structural member and said powertrain; and
a hydraulic device torque reacting mount bushing flexibly interconnecting said first and second torque reacting mount component members and providing passively decoupled pitch damping with respect to high and low amplitudes of vibration of powertrain pitch.

2. The powertrain mounting system of claim 1, wherein said hydraulic device torque reacting mount bushing comprises:
an outer shell;
a main elastic element having a first side and an opposite second side, wherein distal ends of said main elastic element are stationarily disposed with respect to said outer shell;
a main liquid reservoir disposed at said first side of said main elastic element, wherein said second side of the main elastic element is exposed to the atmosphere;
a secondary liquid reservoir;
a flexible bellows elastically separating said secondary liquid reservoir from the atmosphere;
a bounce inertia track extending between, and hydraulically communicating with, said main liquid reservoir and said secondary liquid reservoir;
a decoupler fluid passage extending between, and hydraulically communicating with, said main liquid reservoir and said secondary liquid reservoir; and
a decoupler system hydraulically connected with said decoupler fluid passage, said decoupler system comprising:
a pair of parallel and mutually spaced apart perforated side walls; and
a compliant membrane loosely disposed between said perforated sidewalls, said compliant membrane being sized to selectively occlude in superposing relation the perforations of said perforated sidewalls;
wherein for low amplitude vibration of said main elastic element with respect to said outer shell not more than minimal hydraulic damping and stiffness is provided via said decoupler fluid passage, absence of said compliant membrane occluding the perforations of the perforated sidewalls and free movement of said compliant membrane responsive to said low amplitude vibration; and
wherein for high amplitude vibration of said main elastic element with respect to said outer shell, hydraulic damping and stiffness greater than the minimal hydraulic damping is provided via said bounce inertia track and said compliant membrane occluding the perforations of one of the perforated sidewalls responsive to the high amplitude vibration.

3. The powertrain mounting system of claim 2, wherein the powertrain mounting system is a four-point neutral torque roll axis powertrain mounting system, and wherein said at least one torque reacting mount component comprises a forward torque reacting bushing mount; and a rearward torque reacting bushing mount.

4. The powertrain mounting system of claim 2, wherein the powertrain mounting system is a pendular powertrain mounting system, and wherein said at least one torque reacting mount component comprises a torque reacting strut mount.

5. The powertrain mounting system of claim 1, wherein said hydraulic device torque reacting mount bushing comprises:
an outer shell;
a molded elastic bushing disposed within said outer shell, said molded elastic bushing including a main elastic element, said main elastic element having a first side and an opposite second side, wherein distal ends of said main elastic element are integrally connected with said molded elastic bushing;
a main liquid reservoir disposed at said first side of said main elastic element, wherein said second side of the main elastic element is exposed to the atmosphere;
a secondary liquid reservoir;
a flexible bellows elastically separating said secondary liquid reservoir from the atmosphere;
a bounce inertia track extending between, and hydraulically communicating with, said main liquid reservoir and said secondary liquid reservoir;
a decoupler fluid passage extending between, and hydraulically communicating with, said main liquid reservoir and said secondary liquid reservoir; and
a decoupler system hydraulically connected with said decoupler fluid passage, said decoupler system comprising:
a pair of parallel and mutually spaced apart perforated side walls; and
a compliant membrane loosely disposed between said perforated sidewalls, said compliant membrane being sized to selectively occlude in superposing relation the perforations of said perforated sidewalls;
wherein for low amplitude vibration of said main elastic element with respect to said outer shell not more than minimal hydraulic damping and stiffness is provided via said decoupler fluid passage, absence of said compliant membrane occluding the perforations of the perforated sidewalls and free movement of said compliant membrane responsive to said low amplitude vibration; and
wherein for high amplitude vibration of said main elastic element with respect to said outer shell, hydraulic damping and stiffness greater than the minimal hydraulic damping is provided via said bounce inertia track and said compliant membrane occluding the perforations of one of the perforated sidewalls responsive to the high amplitude vibration.

6. The powertrain mounting system of claim 5, wherein the powertrain mounting system is a four-point neutral torque roll axis powertrain mounting system, and wherein said at least one torque reacting mount component comprises a forward torque reacting bushing mount; and a rearward torque reacting bushing mount.

7. The powertrain mounting system of claim 5, wherein the powertrain mounting system is a pendular powertrain mounting system, and wherein said at least one torque reacting mount component comprises a torque reacting strut mount.

8. A motor vehicle powertrain mounting system comprising:
a powertrain having a torque roll axis;
a structural member upon which said powertrain is mountable;
a plurality of load bearing mounts supporting said powertrain with respect to said structural member, wherein said load bearing mounts are disposed in alignment with the torque roll axis of said powertrain;
at least one torque reacting mount component connected to said structural member and said powertrain and disposed so as to react to powertrain pitch torque around said torque roll axis, said torque reacting mount component comprising:
a first torque reacting mount component member connected to one of said structural member and said powertrain;
a second torque reacting mount component member connected to the other of said structural member and said powertrain; and
a hydraulic device torque reacting mount bushing flexibly interconnecting said first and second torque reacting mount component members and providing passively decoupled pitch damping with respect to high and low amplitudes of vibration of powertrain pitch, said hydraulic device torque reacting mount bushing comprising:
an outer shell;
a molded elastic bushing disposed within said outer shell, said molded elastic bushing including a main elastic element, said main elastic element having a first side and an opposite second side, wherein distal ends of said main elastic element are integrally connected with said molded elastic bushing;
a main liquid reservoir disposed at said first side of said main elastic element, wherein said second side of the main elastic element is exposed to the atmosphere;
a secondary liquid reservoir;
a flexible bellows elastically separating said secondary liquid reservoir from the atmosphere;
a bounce inertia track extending between, and hydraulically communicating with, said main liquid reservoir and said secondary liquid reservoir;
a decoupler fluid passage extending between, and hydraulically communicating with, said main liquid reservoir and said secondary liquid reservoir; and
a decoupler system hydraulically connected with said decoupler fluid passage, said decoupler system comprising:
a pair of parallel and mutually spaced apart perforated side walls; and
a compliant membrane loosely disposed between said perforated sidewalls, said compliant membrane being sized to selectively occlude in superposing relation the perforations of said perforated sidewalls;
wherein for low amplitude vibration of said main elastic element with respect to said outer shell not more than minimal hydraulic damping and stiffness is provided via said decoupler fluid passage, absence of said compliant membrane occluding the perforations of the perforated sidewalls and free movement of said compliant membrane responsive to said low amplitude vibration; and
wherein for high amplitude vibration of said main elastic element with respect to said outer shell, hydraulic damping and stiffness greater than the minimal hydraulic damping is provided via said bounce inertia track and said compliant membrane occluding the perforations of one of the perforated sidewalls responsive to the high amplitude vibration.

9. The powertrain mounting system of claim 8, wherein the powertrain mounting system is a four-point neutral torque roll axis powertrain mounting system, and wherein said at least one torque reacting mount component comprises a forward torque reacting bushing mount; and a rearward torque reacting bushing mount.

10. The powertrain mounting system of claim 8, wherein the powertrain mounting system is a pendular powertrain mounting system, and wherein said at least one torque reacting mount component comprises a torque reacting strut mount.
